(19) United States
(12) Patent Application Publication
(10) Pub. No.: US 2009/0190832 A1
(43) Pub. Date: Jul. 30, 2009

(54) IMAGE PROCESSING DEVICE

(76) Inventors: Ryuichi MIYAKOSHI, Osaka (JP); Kazuyuki Imagawa, Osaka (JP)

Correspondence Address: MCDERMOTT WILL & EMERY LLP, 600 13TH STREET, NW, WASHINGTON, DC, 20005-3096, US

(21) Appl. No.: 12/337,319

(22) Filed: Dec. 17, 2008

(30) Foreign Application Priority Data
Jan. 24, 2008 (JP) 2008-013725

(51) Int. Cl. G06K 9/34; G06K 9/40

(52) U.S. Cl. 382/173; 382/274

(57) ABSTRACT

An inputted image is divided into a plurality of blocks, and an image quality thereof is corrected for each of the divided blocks based on information of image data of the respective blocks. Therefore, even in the case where a region where the dark-area-gradation deterioration is generated and a region where the bright-area-gradation deterioration is generated are included in an image, the inputted image is divided so that blocks correspond to the region where the dark-area-gradation deterioration is generated and the region where the bright-area-gradation deterioration is generated, respectively, and then corrected. As a result, the region where the dark-area-gradation deterioration is generated and the region where the bright-area-gradation deterioration is generated can be corrected at the same time.

### FIELD OF THE INVENTION

The present invention relates to an image processing method, an image processing device and an imaging device which are suitable for accurately detecting a particular region, for example, a face region under such an environment in an imaging operation that generate the dark-area-gradation deterioration or bright-area-gradation deterioration due to low-light intensity, backlight or the like.

### BACKGROUND OF THE INVENTION

In recent years, imaging devices and image processing devices such as digital cameras (digital still camera, digital video camera, camera-equipped mobile telephone), monitor cameras, and door phone cameras are generally provided with a function for detecting a face region. In a digital still camera, a detected face region is AF-controlled (automatic focus) or AE-controlled (automatic exposure). In a monitor camera, a detected face region is memorized. Thus they are used to identify a suspicious individual.

In order to detect the face region, various technologies have been proposed, such as a detection method based on a positional relationship between standard parts in a face (eyes, mouth or the like), a detection method based on colors and edge information of a face, a detection method based on comparison to data of features of a face prepared in advance, and the like.

However, a level of accuracy in the detection, in any of the foregoing methods, largely depends on an environment where an image to be detected is obtained. In an image obtained in such an environment as low-light intensity, backlight, or the like, for example, there is a high possibility that the dark-area-gradation deterioration or bright-area-gradation deterioration is generated. In the case where the dark-area-gradation deterioration or bright-area-gradation deterioration is generated in the face region, in particular, the accuracy in the detection of the face region is significantly deteriorated. In order to solve the conventional problem, an imaging device configured to accurately detect the face region under high contrast imaging conditions due to backlight, or the like was proposed as a related technology, an example of which is recited in 2007-210963 of the Japanese Patent Applications Laid-Open.

FIG. 25 is a block diagram illustrating a constitution of the imaging device recited in 2007-210963 of the Japanese Patent Applications Laid-Open. An imaging device 214 illustrated in the drawing comprises an optical system 201 including an object lens, an imaging element 202 which is made of CCD, an analog signal processor 203 which converts an imaging signal from the imaging element 202 into an analog image signal and provides such processing as noise-reduction and gain-adjustment to the converted analog image signal, an A/D converter which converts the image signal processed by the analog signal processor 203 into a digital signal, a digital signal processor 205 which makes adjustments of an image quality of the A/D-converted image signal such as gamma adjustment and white balance adjustment, a frame data memory 210 which stores signal-processed frame data, a face region detector 209 which detects a face region of an individual from the frame data of the frame data memory 210, an image quality corrector 208 which corrects the image quality of the face region detected by the face region detector 209, a frame outputter 211 which reads the frame data from the frame data memory 210, an encoder 212 which encodes the outputted frame data according to the JPEG (or MPEG) method, a data transmitter 213 which converts the encoded frame data into transmission data and transmits the resulting data to a centralized monitoring station or the like, via a communication line, a histogram generator 206 which generates a brightness histogram based on pixel information of the frame data, and a correction controller 207 which corrects levels of brightness and contrast based on the brightness histogram.

In the imaging device 214, the brightness histogram is generated for the frame data of an obtained image by the histogram generator 206, the brightness levels are divided into a range of dark areas, a range of intermediate brightness and a range of bright areas, and the accumulated number of pixels included in the range of dark areas or in the range of bright areas is compared to a threshold value set in advance by the correction controller 207. In the case where the number of pixels included in either of the ranges exceeds the threshold value, the imaging element 202, analog signal processor 203 and digital signal processor 205 are controlled based on the recognition that the dark-area-gradation deterioration or bright-area-gradation deterioration is generated in the image, so that the levels of brightness and contrast are corrected. As a result, the dark-area-gradation deterioration or bright-area-gradation deterioration is corrected so that the accuracy in the detection of the face region is improved.

The imaging device recited in 2007-210963 of the Japanese Patent Applications Laid-Open is, however, configured to correct the image quality for the entire frame data in an image whose face region underwent the dark-area-gradation deterioration or bright-area-gradation deterioration due to an unfavorable imaging environment such as low-light intensity or backlight. Therefore, all of the face regions included in the same frame data cannot be corrected at the same time in, for example, an image 301 including a face region where the dark-area-gradation deterioration is generated and the face region where the bright-area-gradation deterioration is generated in the same frame data as illustrated in FIG. 26A, an image 302 including face regions where the dark-area-gradation deterioration is generated at different levels as illustrated in FIG. 26B, or an image including face regions where the bright-area-gradation deterioration is generated at different levels. Thus, it is not possible to detect a plurality of face regions at the same time.

### SUMMARY OF THE INVENTION

Therefore, a main object of the present invention is to correct a region where the dark-area-gradation deterioration is generated and a region where the bright-area-gradation deterioration is generated, for example, which are included in an image obtained in an unfavorable environment such as low-light intensity or backlight, at the same time.

An image processing method according to the present invention comprises a step of dividing an image based on image data into a plurality of blocks, and a step of correcting an image quality of the image on a block-by-block basis based on information of the image data of the respective divided blocks.

An image processing device according to the present invention comprises an image data memory in which inputted image data is stored, a data divider for dividing an image based on the image data into a plurality of blocks and generating the image data of the respective blocks, an image quality corrector for correcting an image quality of the image, and a correction controller for controlling the correction of the image quality by the image quality corrector on a block-by-block basis based on information of the image data of the respective blocks divided by the data divider.

According to the present invention, the image quality is corrected for each of the plurality of blocks obtained by the division of the image based on the information of the image data of each block. Therefore, even in the case of an image including a region where the dark-area-gradation deterioration is generated and a region where the bright-area-gradation deterioration is generated, for example, the image quality is corrected after the image is divided into blocks so that blocks will correspond to the region where the dark-area-gradation deterioration is generated and the region where the bright-area-gradation deterioration is generated. As a result, the region where the dark-area-gradation deterioration is generated and the region where the bright-area-gradation deterioration is generated can be corrected at the same time.

An imaging device according to the present invention comprises an imaging element for receiving an incident light of a photographic subject via an optical lens, converting the received light into an imaging signal and outputting the imaging signal, an A/D converter for converting the imaging signal outputted from the imaging element into a digital signal, a digital signal processor for digitally processing the digital signal outputted from the A/D converter, the image processing device according to the present invention for processing the image data outputted from the digital signal processor, and an image data outputter for outputting the image-processed image data outputted from the image processing device outside.

### BRIEF DESCRIPTION OF THE DRAWINGS

These and other objects as well as advantages of the invention will become clear by the following description of preferred embodiments of the invention. A number of benefits not recited in this specification will come to the attention of the skilled in the art upon the implementation of the present invention.

FIG. 1 is a block diagram illustrating a constitution of an imaging device including an image processing device according to a preferred embodiment of the present invention.

FIG. 2 is a flow chart used for the description of an operation of the imaging device illustrated in FIG. 1.

FIG. 3 is an illustration of the division of an image into blocks according to a preferred embodiment 1 of the present invention.

FIG. 4 is an illustration of γ characteristics according to the preferred embodiment 1.

FIG. 5 is an illustration of an image obtained after an image quality thereof is corrected according to the preferred embodiment 1.

FIG. 6 is an illustration of an inputted image according to a preferred embodiment 2 of the present invention.

FIG. 7 is an illustration of the division of the inputted image illustrated in FIG. 6 into blocks according to the preferred embodiment 1.

FIG. 8 is an illustration of an image obtained after an image quality thereof is corrected according to the preferred embodiment 1.

FIG. 9 is an illustration of the division of an image into blocks according to the preferred embodiment 2.

FIG. 10 is an illustration of an image obtained after an image quality thereof is corrected according to the preferred embodiment 2.

FIG. 11 is an illustration of the division of an image into blocks according to the preferred embodiment 2.

FIG. 12 is an illustration of an image obtained after an image quality thereof is corrected according to the preferred embodiment 2.

FIG. 13 is an illustration of an inputted image according to a preferred embodiment 3 of the present invention.

FIG. 14 is an illustration of the division of the inputted image illustrated in FIG. 13 into blocks according to the preferred embodiment 2.

FIG. 15 is an illustration of an image obtained after an image quality thereof is corrected according to the preferred embodiment 2.

FIG. 16 is an illustration of the division of an image into blocks according to a preferred embodiment 3 of the present invention.

FIG. 17 is an illustration to describe steps for deciding correction parameters according to the preferred embodiment 3.

FIG. 18 is an illustration to describe steps for deciding the correction parameters according to the preferred embodiment 3.

FIG. 19 is an illustration to describe steps for deciding the correction parameters according to the preferred embodiment 3.

FIG. 20 is an illustration to describe steps for deciding the correction parameters according to the preferred embodiment 3.

FIG. 21 is an illustration to describe steps for deciding the correction parameters according to the preferred embodiment 3.

FIG. 22 is an illustration to describe steps for deciding the correction parameters according to the preferred embodiment 3.

FIG. 23 is an illustration of the division of an inputted image into blocks according to a preferred embodiment 4 of the present invention.

FIG. 24 is an illustration of a virtual combination of the blocks of the inputted image according to the preferred embodiment 4.

FIG. 25 is a block diagram illustrating a constitution of a related technology.

FIG. 26A is an illustration of an image including a face region where the dark-area-gradation deterioration is generated and a face region where the bright-area-gradation deterioration is generated in the same frame data.

FIG. 26B is an illustration of an image including face regions where the dark-area-gradation deterioration is generated at different levels.

### DETAILED DESCRIPTION OF PREFERRED EMBODIMENTS

Hereinafter, preferred embodiments of the present invention are described referring to the drawings. The preferred embodiments described below are merely examples and can be variously modified.

### Preferred Embodiment 1

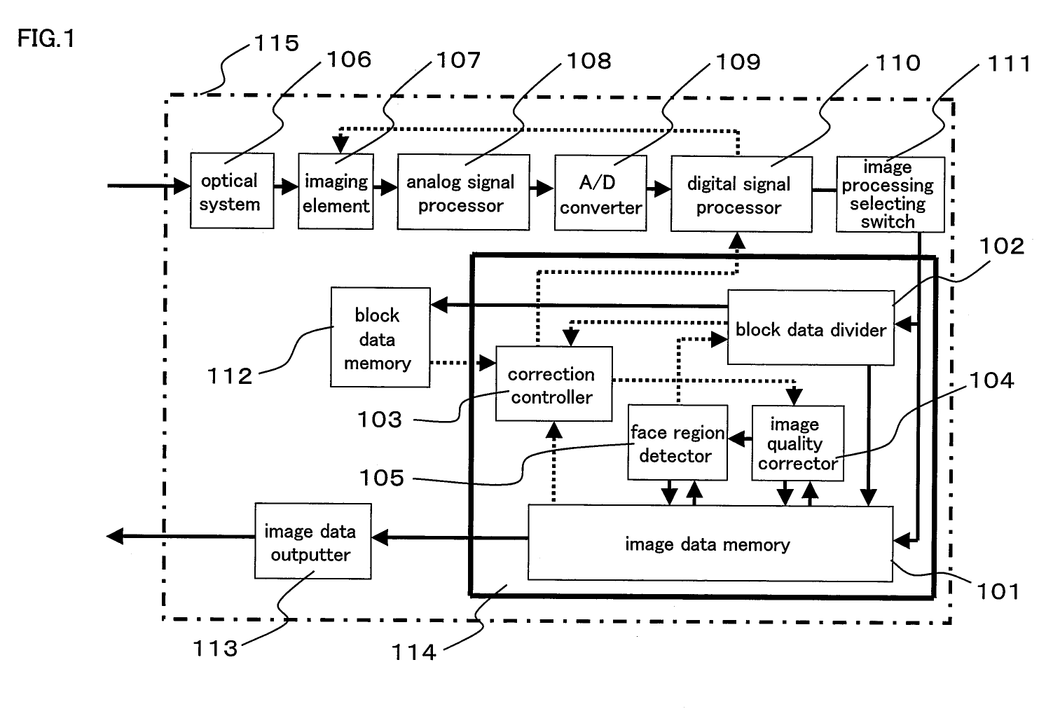

FIG. 1 is a block diagram illustrating an overall constitution of an imaging device and an image processing device according to a preferred embodiment 1 of the present invention. An image processing device 114 according to the present preferred embodiment comprises an image data memory 101 in which inputted image data is stored, a block data divider 102 which generates the image data (block data) of each of a plurality of blocks obtained by the division of an image based on the image data, a correction controller 103 which controls correction parameters for correcting an image quality based on information of the block data outputted from the block data divider 102, an image quality corrector 104 which corrects the image quality using the correction parameters decided by the correction controller 103, and a face region detector 105 which detects a face region of a person which is a particular region in the image data stored in the image data memory 101. The face region detector 105 may adopt any of conventional detection methods such as a detection method based on a positional relationship between standard parts in a face (eyes, mouth or the like), a detection method based on colors and edge information of a face, and a detection method based on comparison to data of features in a face prepared in advance.

In the detection method based on the colors and edge information of a face, for example, an image is divided into a flesh-color region and a non-flesh-color region, and edges in the image are detected. Then, respective sections in the image are classified into edge sections and non-edge sections, and a group of regions in the image each of which belongs to the flesh-color region and is classified as the non-edge section is detected as a face candidate region. In the detection method based on the comparison to the data of features in a face prepared in advance, fetched data is compared to the data of various features in a face memorized in advance concerning the outline, eyes, nose, eyebrows, ears and the like, so that the face region is detected.

An imaging device 115 according to the preferred embodiment 1 comprises an optical system 106 which converges light of a photographic subject on an imaging element 107, an imaging element 107, such as CCD, which images the photographic subject obtained by the optical system 106, an analog signal processor 108 which provides predetermined processing, such as noise reduction, to an analog imaging signal outputted from the imaging element 107, an A/D converter 109 which converts the processed analog imaging signal outputted from the analog signal processor 108 into a digital imaging signal, a digital signal processor 110 which provides predetermined processing, such as white-balance adjustment, to the digital imaging signal outputted from the A/D converter 109, an image processing device 114 which detects a face region by providing predetermined processing to the processed digital imaging signal (image data) outputted from the digital signal processor 110, and an image data outputter 113 which outputs to the outside image data in which the information of the face region outputted from the image processing device 114 included.

In the preferred embodiment 1, the imaging device 115 comprises a block data memory 112 in which the block data outputted from the block data divider 102 is stored, and an image processing selecting switch SW111 which changes whether or not the image quality is corrected by the image processing device 114.

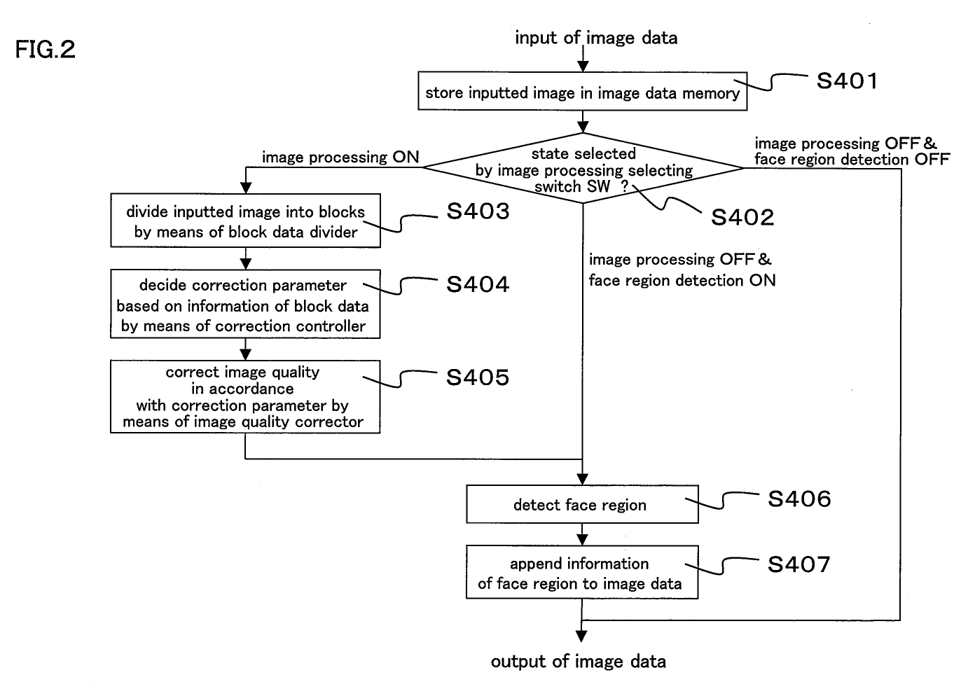

Next, an operation of the image processing device 114 is described referring to a flow chart illustrated in FIG. 2. First, image data is inputted to the image processing device 114 and memorized in the image data memory 101 (S401). How the image data is thereafter processed changes in accordance with the state selected by the image processing selecting switch SW111 (S402).

In the case where the selection by the image processing selecting switch SW111 indicates that the image processing is ON, the inputted image is divided into blocks each having an arbitrary size in accordance with the size of a face region detected by the block data divider 102 (S403). Correction parameters are decided by the correction controller 103 on a block-by-block basis based on the information of the respective block data (S404). The image quality is corrected in accordance with the correction parameters by the image quality corrector 104 (S405). The face region is detected by the face region detector 105 with respect to the image data obtained after the image quality thereof is corrected (S406). The information of the face region is appended to the inputted image data (S407), and the resulting image data is outputted.

In the case where the selection by the image processing selecting switch SW111 indicates that the image processing is OFF and the detection of the face region is ON, the face region is detected with respect to the inputted image data by the face region detector 105 (S406). Then, the information of the face region is appended to the inputted image data (S407), and the resulting image data is outputted. In the case where the selection by the image processing selecting switch SW111 indicates that the image processing is OFF and the detection of the face region is OFF, the inputted image data is directly outputted.

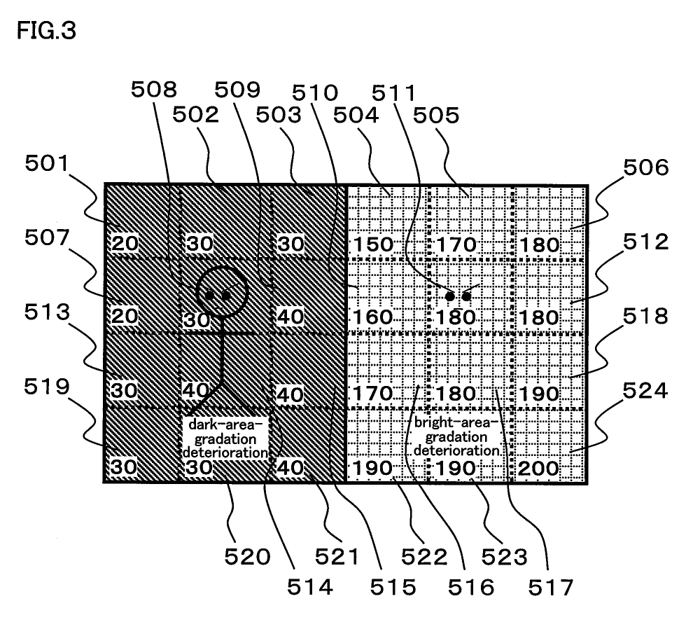

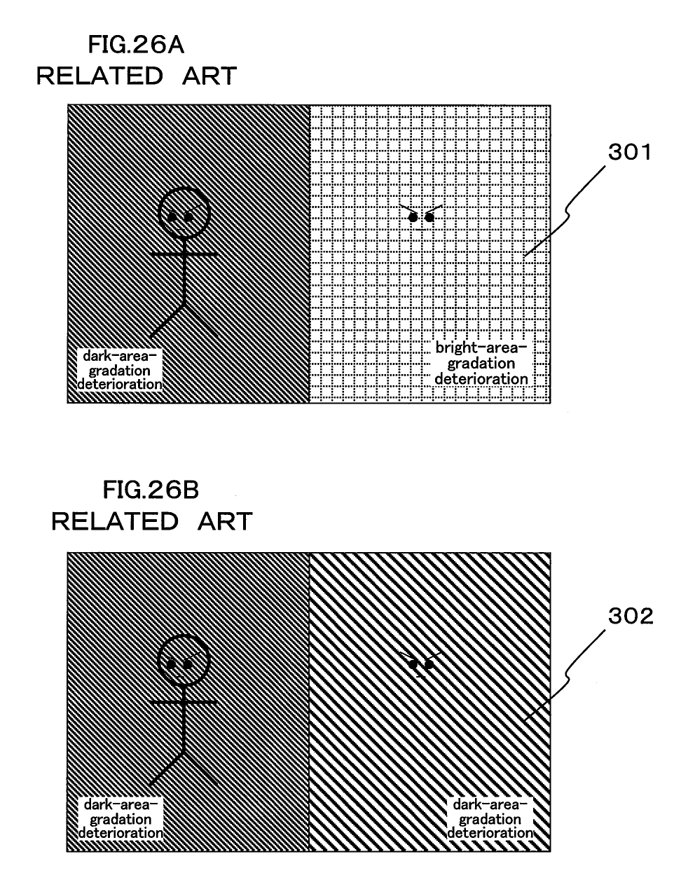

Below are described a method of dividing an image into blocks by means of the block data divider 102 and a method of deciding correction parameters by means of the correction controller 103 in the case where the image-processing-ON is selected by the image processing selecting switch SW111. In the case where the image 301, which includes a face region where the dark-area-gradation deterioration is generated and a face region where the bright-area-gradation deterioration is generated in the same image as illustrated in FIG. 26A, is inputted, first, the inputted image is divided into a certain number of blocks by the block data divider 102. In this description, it is assumed that the inputted image is equally divided into 6×4=24 blocks 501-524 as shown in FIG. 3. Next, an average brightness level in each of the blocks 501-524 is calculated by the correction controller 103, and correction parameters are calculated for each of the blocks. FIG. 3 shows average values of the brightness levels of the blocks 501-524 in a manner similar to the drawings described later.

In the example illustrated in FIG. 3, the brightness level average value in each of the blocks 501-524 is as follows: block 501=20; block 502=30; block 503=30; block 504=150; block 505=170; block 506=180; block 507=20; block 508=30; block 509=40; block 510=160; block 511=180; block 512=180; block 513=30; block 514=40; block 515=40; block 516=170; block 517=180; block 518=190; block 519=30; block 520=30; block 521=40; block 522=190; block 523=190; and block 524=200.

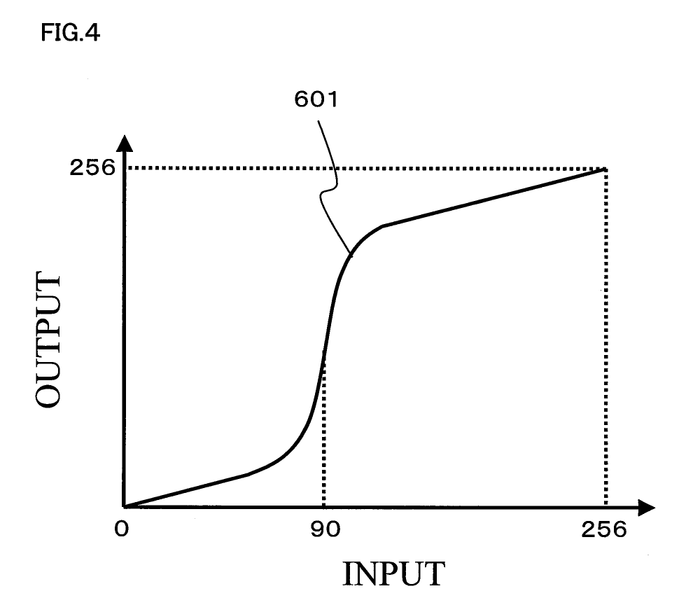

In the case where the gain correction and γ correction are performed by the image quality corrector 104 in order to correct the image quality, a parameter for the gain correction is decided for each of the blocks so that the brightness level average in each of the blocks obtained by the division of the image will be, for example, 90, and a parameter for the γ correction is decided for each of the blocks so that the vicinity of the brightness level 90 will have a γ characteristic 601 showing such a drastic rise as illustrated in FIG. 4.

In the example illustrated in FIG. 3, the parameters for the gain correction in the respective blocks 501-524 are decided such that: block 501=x9/2; block 502=x3; block 503=x3; block 504=x3/5; block 505=x9/17; block 506=x1/2; block 507=x9/2; 508=x3; block 509=x9/4; block 510=x9/16; block 511=x1/2; block 512=x1/2; block 513=x3; block 514=x9/4; block 515=x9/4; block 516=x9/17; block 517=x1/2; block 518=x9/19; block 519=x3; block 520=x3; block 521=x9/4; block 522=x9/19; block 523=x9/19; and block 524=x9/20.

These correction parameters are used to calculate corrected values in the gain correction of the blocks 501-524. For example, the gain is corrected to 9/2 times in the block 501, the gain is corrected to three times in the block 502, and the other blocks are corrected in a similar manner. Then, the parameters for the γ correction in the blocks 501-524 are decided such that the γ characteristic is shown as illustrated in FIG. 4.

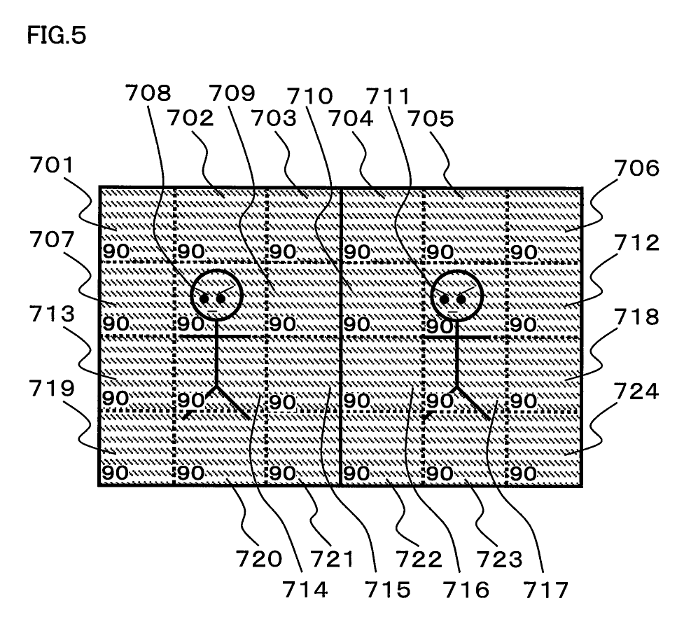

The image quality corrector 104 corrects the image quality for each of the blocks based on the decided correction parameters, and the image quality is corrected as illustrated in FIG. 5. Accordingly, even in the image 301 including the face region where the dark-area-gradation deterioration is generated and the face region where the bright-area-gradation deterioration is generated in the same image, the dark-area-gradation deterioration and the bright-area-gradation deterioration are corrected at the same time by the image processing. Thus, a plurality of face regions can be accurately corrected at the same time. Further, the obtained image can have a high contrast as a result of the γ correction.

In the description, the brightness level is used as an example of the information of the block data, and the gain correction and the γ correction are used as examples of the image quality correcting method; however, other information and correction method may be adopted to realize the image processing.

### Preferred Embodiment 2

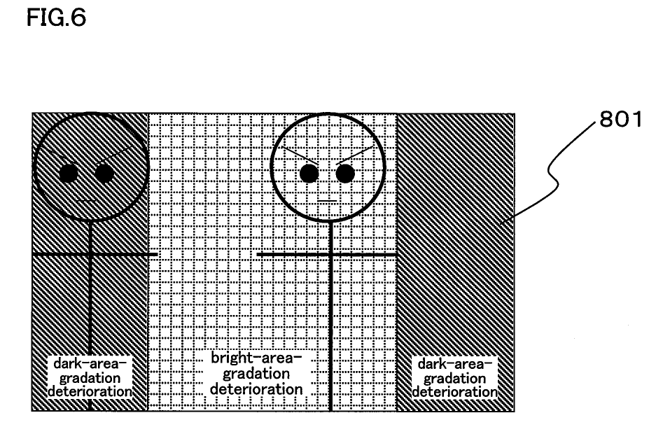

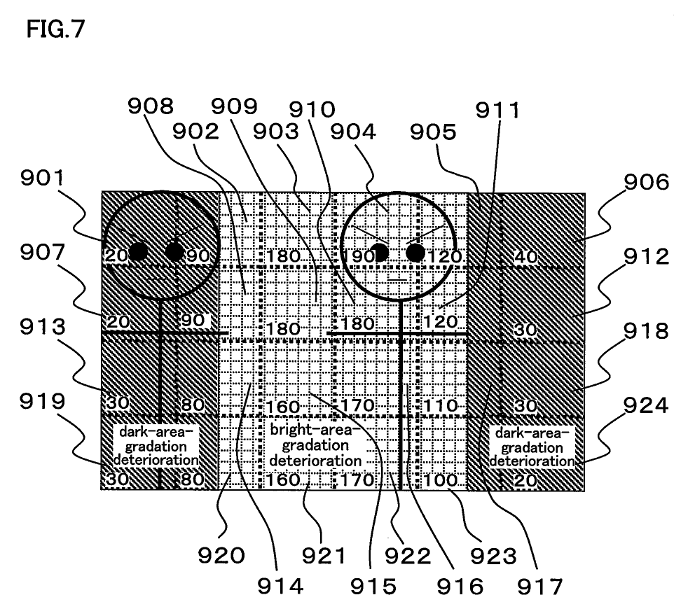

In the preferred embodiment 1, the inputted image is divided into a fixed number of blocks, for example, 6×4=24 blocks. Therefore, face regions cannot be accurately detected in the case where such an image as illustrated in FIG. 6 is inputted. According to the preferred embodiment 1 wherein the inputted image is divided into a fixed number of blocks, the inputted image is divided into, for example, 6×4=24 blocks as illustrated in FIG. 7. Next, the brightness level average in each of blocks 901-924 is calculated, and correction parameters are decided for each of the blocks by the correction controller 103.

In the example illustrated in FIG. 7, the brightness level average in each of the blocks 901-924 is as follows: block 901=20; block 902=90; block 903=180; block 904=190; block 905=120; block 906=40; block 907=20; block 908=90; block 909=180; block 910=180; block 911=120; block 912=30; block 913=30; block 914=80; block 915=160; block 916=170; block 917=110; block 918=30; block 919=30; block 920=80; block 921=160; block 922=170; block 923=100; block 924=20.

As described earlier, the parameters for the gain correction are decided by the correction controller 103 so that the brightness level average values in the respective blocks can be 90. The parameters for the gain correction in the blocks 901-924 are decided such that: block 901=x9/2; block 902=x1; block 903=x1/2; block 904=x9/19; block 905=x3/4; block 906=x9/4; block 907=x9/2; block 908=x1; block 909=x1/2; block 910=x1/2; block 911=x3/4; block 912=x3; block 913=x3; block 914=x9/8; block 915=x9/16; block 916=x9/17; block 917=x9/11; block 918=x3; block 919=x3; block 920=x9/8; block 921=x9/16; block 922=x9/17; block 923=x9/10; block 924=x9/2.

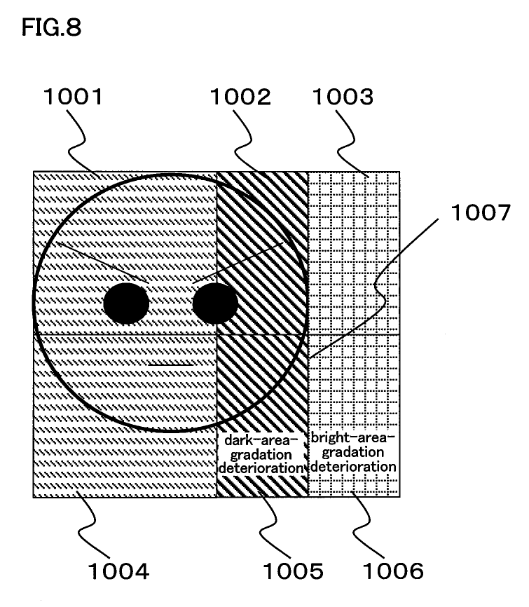

Focusing on the blocks 901 and 902 and the blocks 907 and 908 illustrated in FIG. 7, the parameters for the gain correction in the blocks 902 and 908 are decided as x1, and regions 1002 and 1005 where the dark-area-gradation deterioration is generated existing in the face regions of the respective blocks after the image quality correction remain as illustrated in FIG. 8, which makes it difficult to accurately detect the face regions. The same is also applied to face regions where the bright-area-gradation deterioration is generated included in the blocks 904 and 905, and the blocks 910 and 911 illustrated in FIG. 7.

In FIG. 8, the block 901 after the image quality correction is illustrated as a block 1001, the block 904 after the image quality correction is illustrated as a block 1004, and the face region where the bright-area-gradation deterioration is generated and the face region where the bright-area-gradation deterioration is generated in the block 902 after the image quality correction are respectively illustrated as a block 1002 and a block 1003. The face region where the bright-area-gradation deterioration is generated and the face region where the bright-area-gradation deterioration is generated in the block 908 after the image quality correction are respectively illustrated as a block 1005 and a block 1006.

Therefore, in the preferred embodiment 2, the image is divided into an arbitrary number of blocks by the block data divider 102 in accordance with the size of a face region detected by the face region detector 105. In the technology for detecting a face region, a few stages are generally assumed for the size of the face region before the detection. For example, in the case where the size of an inputted image is QVGA (320×240), first, the face region is detected based on the assumption that the size is 240×240, next, the face region is detected based on the assumption that the size is 200×200, then, the face region is detected based on the assumption that the size is 160×160, and further, the detection is repeated based on the size of the face region gradually reduced. As a result, the face regions in different sizes are detected. Because the number of blocks obtained by the division is thus decided in accordance with the size of the face region, the image quality can be corrected in the unit of a block including the face region.

In the present preferred embodiment, a few different sizes are assumed for the face region in advance, and the image is accordingly divided. However, as an alternative method, the image may be divided into a few different numbers of blocks. For example, the image is equally divided into 3×2=6 blocks so that the face region is detected, next, the image is equally divided into 4×3=12 blocks so that the face region is detected, and then, the image is equally divided into 6×4=24 blocks so that the face region is detected.

Below is described a method of the block division depending on the size of the face region. In the description, the size of the inputted image is QVGA (320×240), and eight different sizes are assumed for the face region detected by the face region detector 105, which are 240×240, 200×200, 160×160, 120×120, 80×80, 40×40, 20×20, and 10×10. Then, the face region is accordingly detected.

Below is given a description based on the assumption that the size of face region is 120×120 and 80×80, referring to FIGS. 9-12. First, the block division in the case where the size of the face region is 120×120 is illustrated in FIG. 9. The inputted image is divided so that the size of one block is 120×120 based on an assumed face region size 1107 of 120×120.

In this example, an image of 320×240 is divided from an left edge thereof, and right-end blocks 1103 and 1106 have a size smaller than 120×120. In the example illustrated in FIG. 9, the brightness level average value in each of the blocks 1101-1106 is as follows: block 1101=60; block 1102=180; block 1103=60; block 1104=80; block 1105=200; and block 1106=70.

In the case where the gain correction is performed as image quality correction by the image quality corrector 104, the correction controller 103 decides the parameters for the gain correction so that the brightness level average values in the respective blocks are 90. More specifically, the parameters for the gain correction in the blocks 1101-1106 are decided such that: block 1101=x3/2; block 1102=x1/2; block 1103=x3/2; block 1104=x9/8; block 1105=x9/20; and block 1106=x9/7.

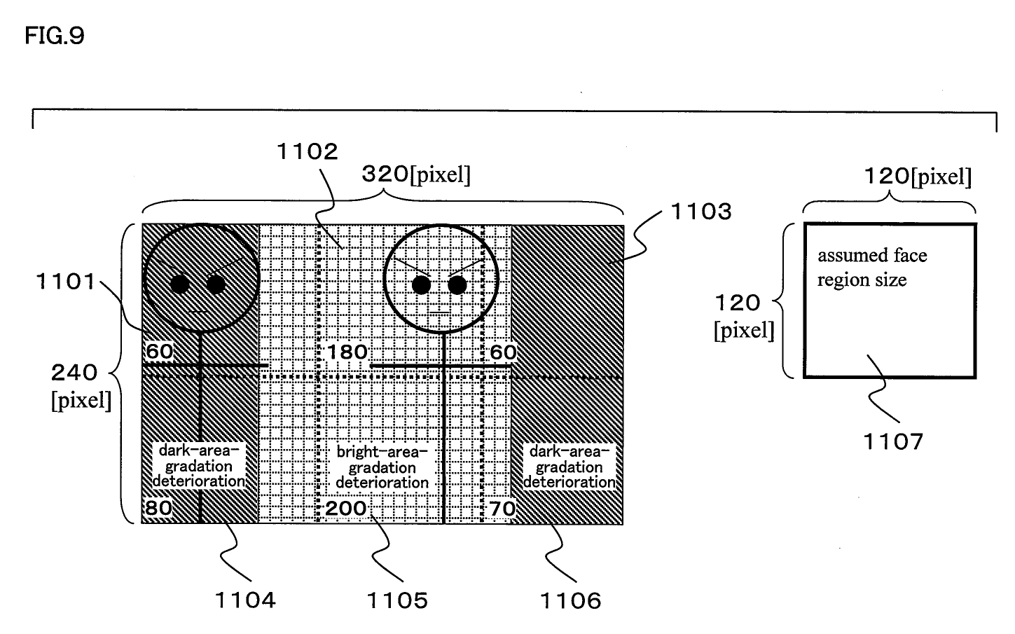

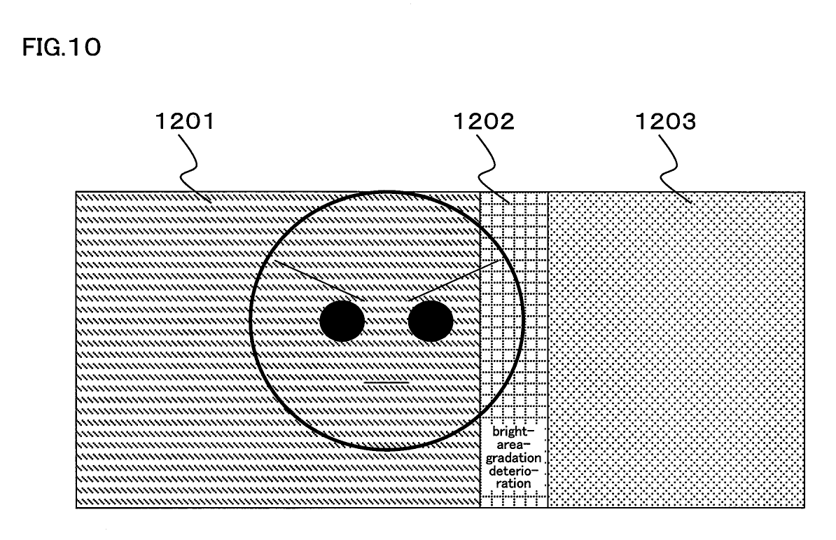

Focusing on the blocks 1102 and 1103 of FIG. 9 as illustrated in FIG. 10, the parameter for the gain correction in the block 1103 is decided as x3/2. Therefore, a region 1102 where the bright-area-gradation deterioration is generated existing in the face region included in the blocks 1102 and 1103 after the image quality correction remains, which makes it difficult to accurately detect the face region. In FIG. 10, the block 1102 after the image quality correction is illustrated as a block 1201, the region where the bright-area-gradation deterioration is generated and the region where the dark-area-gradation deterioration is generated in the block 1103 after the image quality correction are illustrated as a region 1202 and a region 1203, respectively.

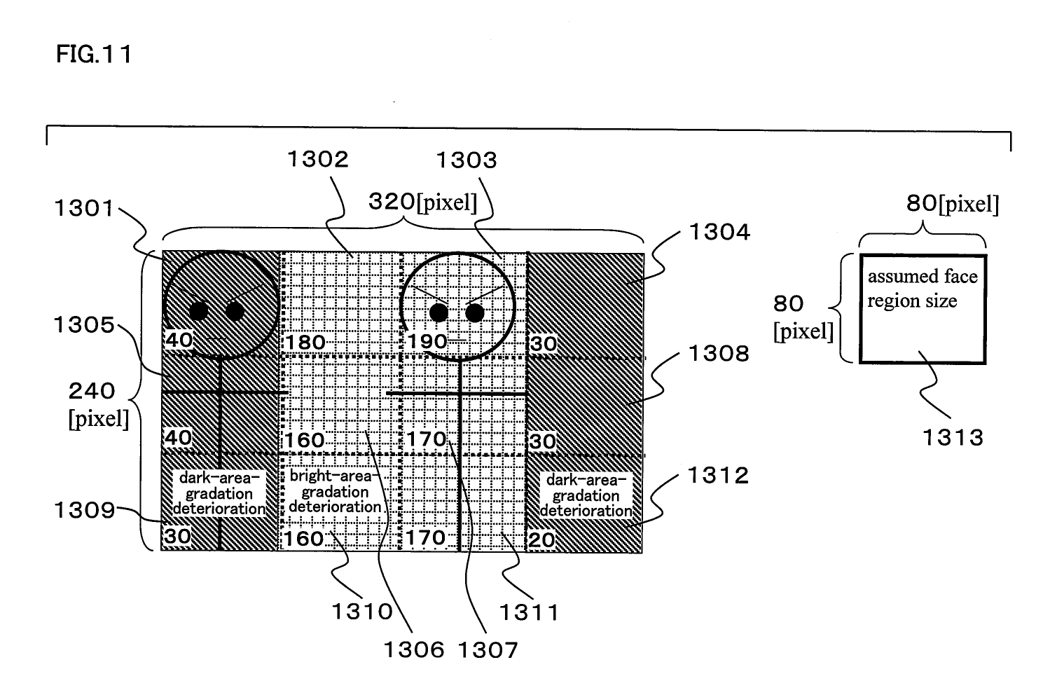

FIG. 11 illustrates the block division in the case where the size of the face region is 80×80. The inputted image is divided so that the size of one block is 80×80 based on an assumed face region size 1313 of 80×80. In the example illustrated in FIG. 11, the bright level average value of each of the blocks 1301-1312 is as follows: block 1301=40; block 1302=180; block 1303=190; block 1304=30; block 1305=40; block 1306=160; block 1307=170; block 1308=30; block 1309=30; block 1310=160; block 1311=170; and block 1312=20.

In the case where the gain correction is performed as the image quality correction by the image quality corrector 104, the correction controller 103 decides the parameters for the gain correction so that the brightness level average in each block is 90. More specifically, the parameters for the gain correction in the blocks 1301-1312 are decided such that: block 1301=x9/4; block 1302=x1/2; block 1303=x9/19; block 1304=x3; block 1305=x9/4; block 1306=x9/16; block 1307=x9/17; block 1308=x3; block 1309=x3; block 1310=x9/16; block 1311=x9/17; and block 1312=x9/2.

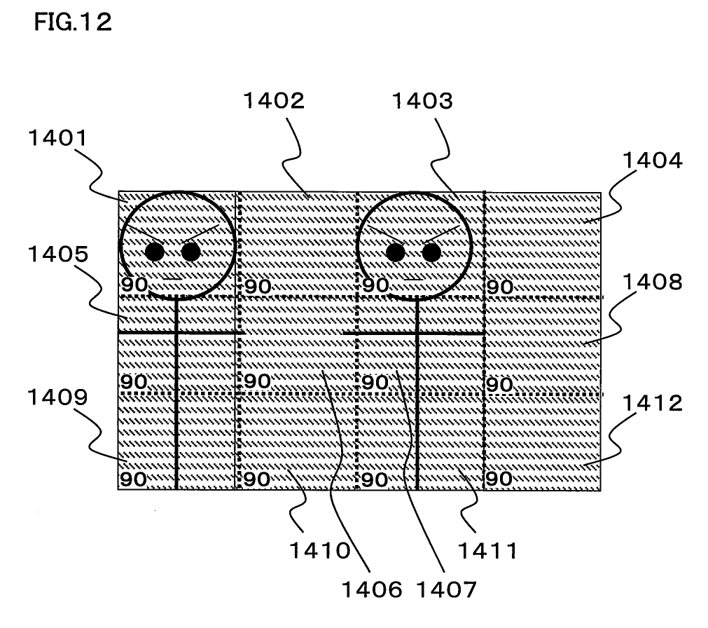

The image quality is corrected on a block-by-block basis by the image quality corrector 104 in accordance with the decided parameters for the gain correction. In the case described above, it becomes possible that the border between the blocks corresponds to the border between the region where the dark-area-gradation deterioration is generated and the region where the bright-area-gradation deterioration is generated in the same image. As a result, as illustrated in FIG. 12, the bright-area-gradation deterioration of the face region remaining in the case of FIG. 10 is corrected, and the face region can be thereby accurately detected.

As so far described, in the preferred embodiment 2, the block division can be arbitrarily performed in accordance with an assumed face region size, and the face region can be accurately detected based on any of the assumed sizes.

The image may be differently divided in a plurality of stages such that the image is divided into a first number of blocks, next, divided into a second number of blocks, and then, divided into a third number of blocks, and thereafter image-processed, wherein, for example, the number of blocks obtained when the face region can be most accurately detected may be adopted.

### Preferred Embodiment 3

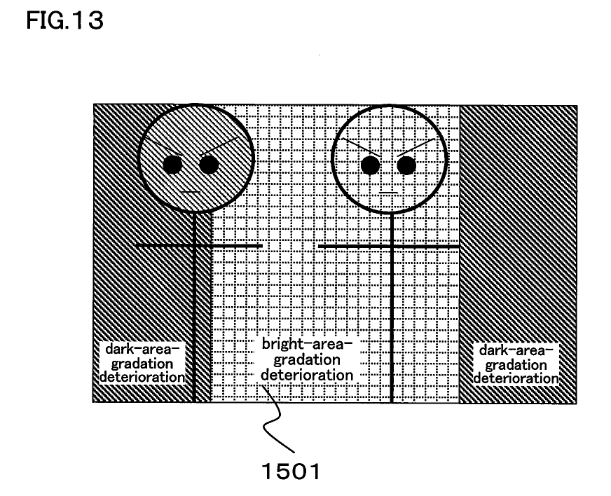

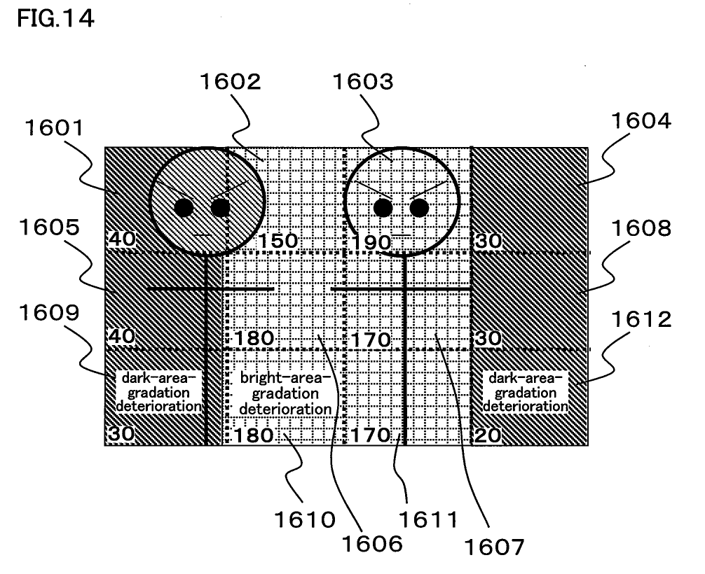

In the preferred embodiment 2, wherein the image quality is corrected for each of the rectangular blocks, the detection of the face region cannot be very accurate in the case where an image including the region where the dark-area-gradation deterioration is generated and the region where the bright-area-gradation deterioration is generated is inputted as illustrated in FIG. 13, for example. More specifically, according to the preferred embodiment 2 wherein the inputted image is divided into the rectangular blocks and the image quality is corrected for each of the blocks, the image is arbitrarily divided in stages into a different number of rectangular blocks in accordance with the size of the face region assumed by the face region detector 105, and the detection of the face region can be considered to be accurate when the actual size of the face region and the block size are very close to each other as illustrated in FIG. 14. Below is illustrated an example relating to such a case.

The brightness level average value in each of blocks 1601-1612 illustrated in FIG. 14 is calculated, and the correction parameters are decided for the respective blocks by the correction controller 103. In the example illustrated in FIG. 14, the brightness level average value in each of the blocks 1601-1612 is as follows: block 1601=40; block 1602=150; block 1603=190; block 1604=30; block 1605=40; block 1606=180; block 1607=170; block 1608=30; block 1609=30; block 1610=180; block 1611=170; and block 1612=20.

In the case where the gain correction is performed as the image quality correction by the image quality corrector 104, the correction controller 103 decides the parameters for the gain correction so that the average of the brightness levels in each block is 90. More specifically, the parameters for the gain correction in the blocks 1601-1612 are decided such that: block 1601=x9/4; block 1602=x3/5; block 1603=x9/19; block 1604=x3; block 1605=x9/4; block 1606=x1/2; block 1607=x9/17; block 1608=x3; block 1609=x3; block 1610=x1/2; block 1611=x9/17; and block 1612=x9/2.

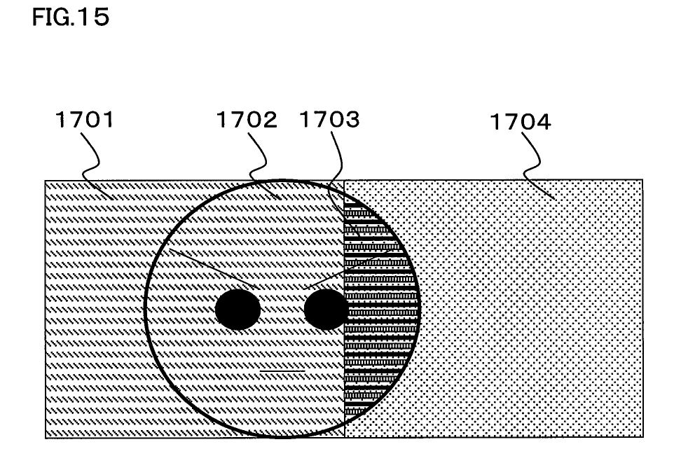

Focusing on the blocks 1601 and 1602 illustrated in FIG. 14, the correction parameters for the blocks 1601 and 1602 are respectively decided as x9/4 and x3/5. Therefore, the blocks 1601 and 1602 after the image quality correction become blocks 1701, 1702, 1703 and 1704 as illustrated in FIG. 15, and a difference in the brightness level is generated on the border between the face regions 1702 and 1703 after the image quality correction. Because the different brightness levels are thus generated in the face region due to the image quality correction, it becomes difficult to accurately detect the face region.

In the preferred embodiment 3, based on information of a targeted block which is a block for which the correction parameter is decided, and information of a peripheral block around the targeted block, correction parameters are decided for each of pixels in the targeted block by the correction controller 103, and the image quality is corrected for each of the pixels by the image quality corrector 104 in accordance with the decided parameters.

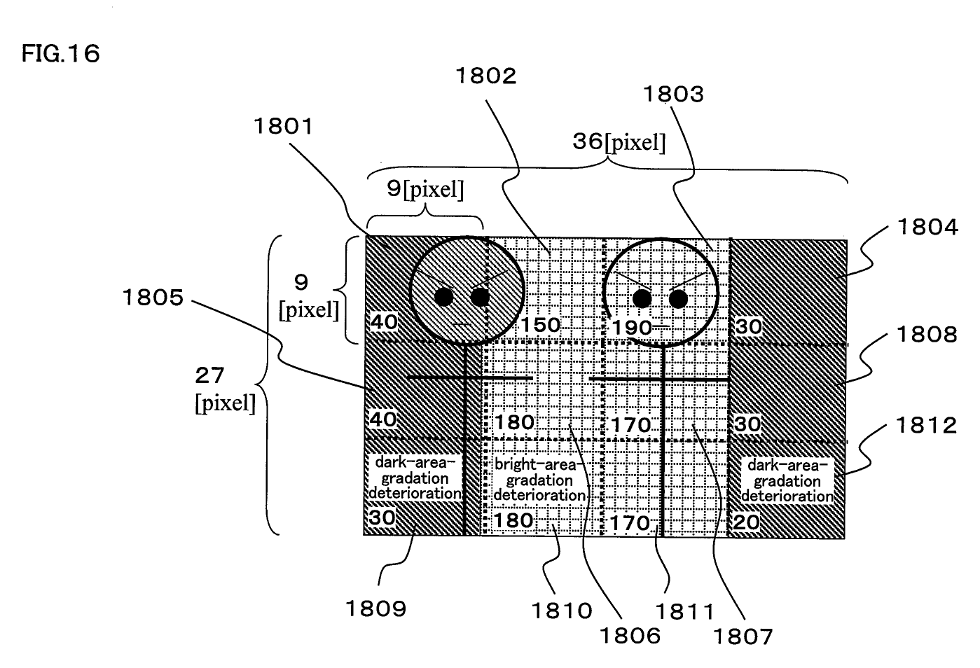

Below is described a method of setting the correction parameters for each of the pixels in the targeted block in view of the peripheral block. As illustrated in FIG. 16, it is assumed that the size of the inputted image is 36×27, and the inputted image is divided into 4×3 blocks (one block: 9×9) according to the preferred embodiment 2, and a block 1801 illustrated in FIG. 16, for example, is set as the targeted block for which the correction parameter is decided for the correction. Below is described a method of deciding the correction parameter for each of the pixels based on information of the targeted block 1801 and information of a peripheral block 1802 around the targeted block 1801.

In the example illustrated in FIG. 16, the brightness level average value in each of blocks 1801-1812 is as follows: block 1801=40; block 1802=150; block 1803=190; block 1804=30; 1805=40; block 1806=180; block 1807=170; block 1808=30; block 1809=30; block 1810=180; block 1811=170; and block 1812=20.

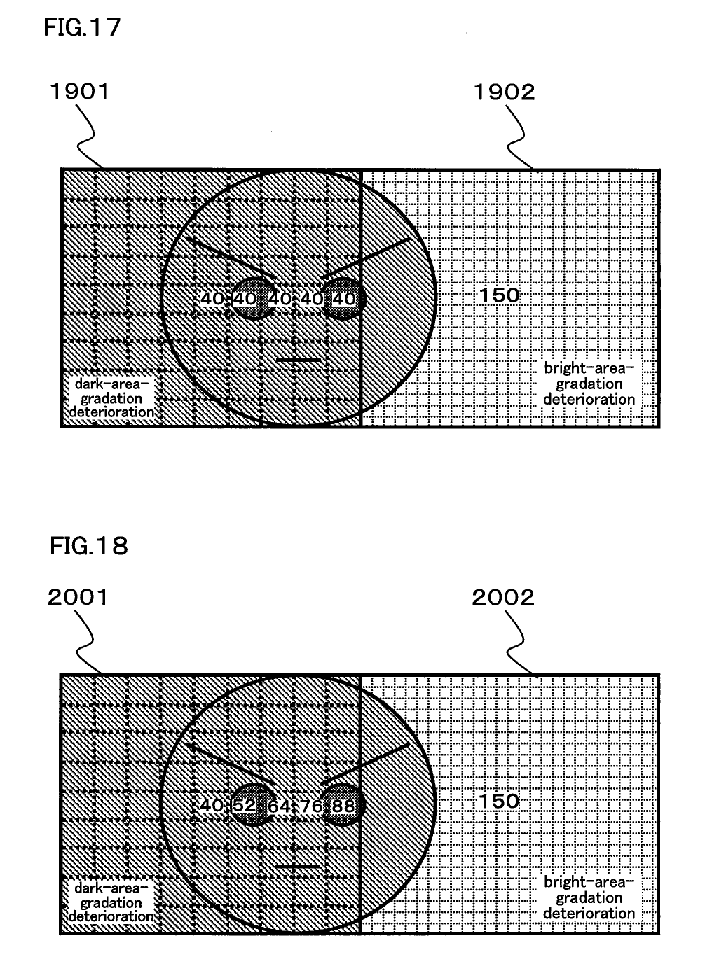

In the case where the gain correction is performed as the image quality correction by the image quality corrector 104, first, the correction controller 103 allocates the brightness level average 40 to all of the pixels in the targeted block as illustrated in FIG. 17. In FIG. 17, numeral values are described only on the pixels relating to the description of the parameter decision, and a block 1901 denotes the targeted block 1801 in which the brightness level 40 is allocated to all of the pixels, and a block 1902 denotes the peripheral block 1802 of which the brightness level average is 150.

Next, a difference in the brightness level average between the targeted bock 1801 and the peripheral block 1802 illustrated in FIG. 16, that is 150−40=110, is calculated, and then allocated to pixels of a targeted block 2001 (1801) so that the brightness level of each pixel will gradually change from the center pixel of the targeted block 1801 to the center pixel of the peripheral block 1802 as illustrated in FIG. 18. More specifically, as illustrated in FIG. 18, the brightness level of the next pixel on the right side of the center pixel of the targeted block 2001 (1801) is replaced with 40+(110/9)×1=52, the brightness level of the second pixel from the center pixel on the right is replaced with 40+(110/9)×2=64, the brightness level of the third pixel from the center pixel on the right is replaced with 40+(110/9)×3=76, and the brightness level of the fourth pixel from the center pixel on the right is replaced with 40+(110/9)×4=88. Any digits after the decimal point are truncated.

Then, the parameter for the gain correction is decided for each of the pixels so that the replaced brightness levels will be 90. More specifically, the correction parameter of the center pixel of the targeted block 1801 is x9/4, the correction parameter of the next pixel on the right side of the center pixel is x90/52, the correction parameter of the brightness level of the second pixel from the center pixel is x90/64, the correction parameter of the brightness level of the third pixel from the center pixel is x90/76, and the correction parameter of the brightness level of the fourth pixel from the center pixel is x90/88.

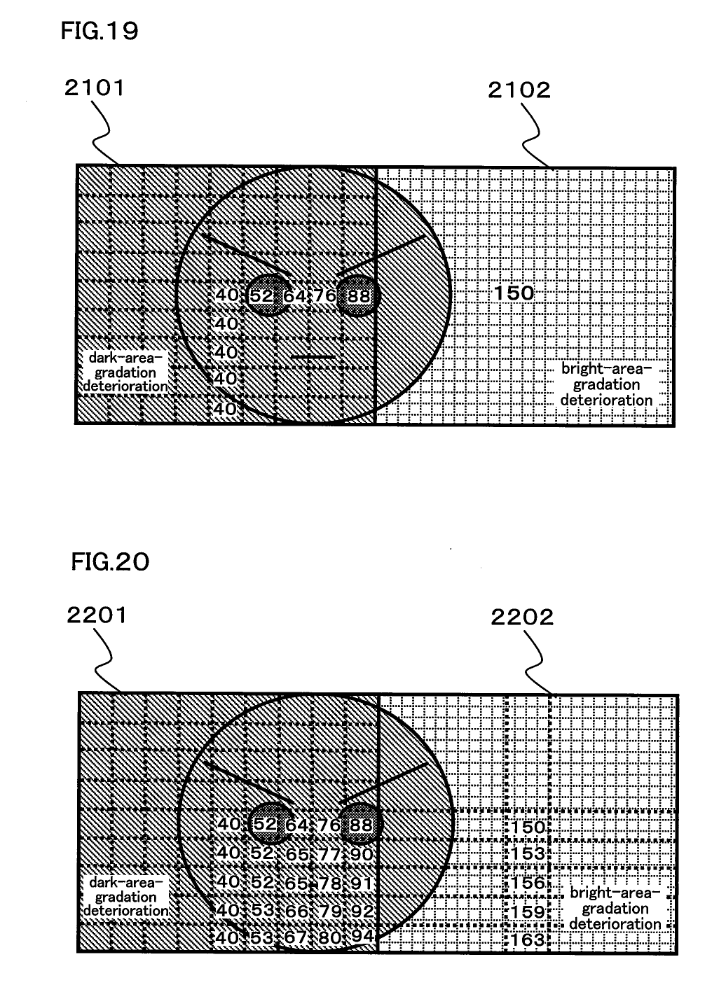

Further, the correction parameters of the respective pixels in the lower right region of the targeted block 2001 (1801) are similarly decided. Referring to the brightness levels of the pixels on the lower side of the center pixel of the targeted block 2101 (1801) is set at 40, which is the same as that of the center pixel of the targeted block 1081, as illustrated in FIG. 19 because the brightness level average of the peripheral block 1805 immediately below the targeted block 1801 is 40, which is equal to that of the targeted block 1801 as illustrated in FIG. 16.

When the correction parameters of the pixels on the right side of the center pixel of the targeted block 1801 are decided, the brightness level average 150 of the next peripheral block 1802 on the right side is directly used as described earlier. However, when the correction parameters of the pixels on the lower side of the center pixel are decided, the brightness level temporarily replaced by means of the brightness level average of the peripheral block 1806 immediately below the peripheral block 1802 is used in place of directly using the brightness level average 150 of the peripheral block 1802. More specifically, in a manner similar to the foregoing description, the brightness level is temporarily replaced on a pixel-by-pixel basis in the peripheral block 1802 as illustrated in a peripheral block 2202 (1802) in FIG. 20 based on the information of the peripheral block 1802 and the information of the peripheral block 1806 immediately therebelow illustrated in FIG. 16. Then, in a manner similar to the foregoing description, the brightness level replacement is performed to all of the rest of the pixels included in the lower right region of the targeted block 1801 by means of the brightness levels temporarily replaced, as illustrated in a targeted block 2201 in FIG. 20, and the parameters for the gain correction are decided so that the brightness level obtained from the replacement on a pixel-by-pixel basis will be 90.

The brightness levels of the pixels on the lower side of the center pixel of the peripheral block 2202 (1802) illustrated in FIG. 20 are temporarily replaced by means of the brightness level average 180 of the peripheral block 1806 immediately therebelow in a manner similar to the foregoing description. More specifically, a difference in the brightness level average between the peripheral block 1802 and the peripheral block 1806 immediately therebelow, that is 180−150=30, is calculated, and then allocated to the pixels of the peripheral block 1802 so that the brightness level will gradually change from the center pixel of the targeted block 1802 to the center pixel of the peripheral block 1806. Accordingly, in the peripheral block 1802, the brightness level of the pixel immediately below the center pixel is temporarily replaced with 153, the brightness level of the second pixel from the center pixel downward is temporarily replaced with 156, the brightness level of the third pixel from the center pixel downward is temporarily replaced with 159, and the brightness level of the fourth pixel from the center pixel downward is temporarily replaced with 163 as illustrated in the peripheral block 2202 in FIG. 20.

Then, in a manner similar to the foregoing description, the brightness levels of the respective pixels in the lower right region of the targeted block 1801 are replaced by means of the brightness levels of the peripheral block 2202 temporarily replaced so that the brightness level will gradually change as illustrated in the targeted block 2201 (1801) in FIG. 20.

Further, the parameters for the gain correction are decided so that the brightness level replaced on a pixel-by-pixel basis will be 90 by means of the brightness levels temporarily replaced with respect to all of the rest of the pixels included in the lower right region of the targeted block 1801.

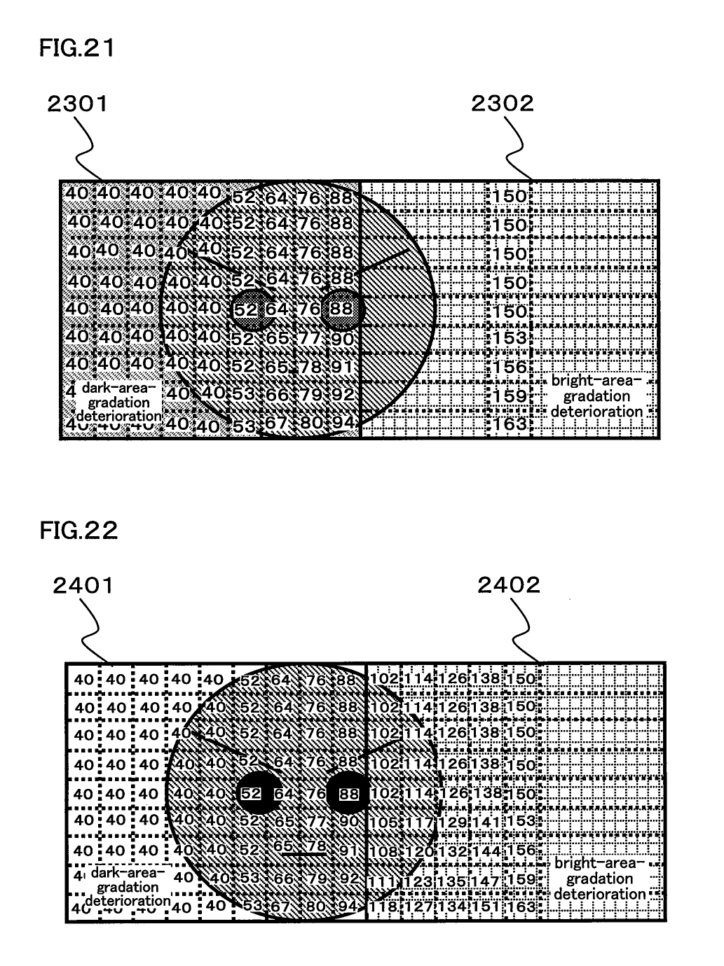

Further, the brightness level is replaced on a pixel-by-pixel basis in the pixels in the upper right, lower left, and upper left regions of the targeted block 1801 in a manner similar to the foregoing description as illustrated in FIG. 21, and the parameters for the gain correction are decided so that the brightness level replaced on a pixel-by-pixel basis will be 90. In this case, the brightness level of the peripheral block 1802 is used to replace the brightness levels of the pixels in the upper right region of the targeted block 1801. However, the brightness levels of the pixels upper than the center pixel of the peripheral block 1802 are 150 as illustrated in a peripheral block 2302 (1802) illustrated in FIG. 21 because there is not any block in the upper direction of the peripheral block 1802.

The targeted block 1801 is a block on the upper-left end of the inputted image as illustrated in FIG. 16, and there is not any adjacent block on the left and thereabove. Therefore, the brightness level average, which is 40, is used for the replacement in the upper left region of the targeted block 1801 as illustrated in the targeted block 2301 in FIG. 21. Further, there is not any block adjacent to the targeted block 1801 on the left, and therefore the brightness level average of the peripheral block 1805 immediately below the targeted block 1801, which is 40, is used for the replacement in the lower left region of the targeted block 1801 as illustrated in the targeted block 2301 in FIG. 21.

Next, the block 1802 is set as the targeted block for which the correction is performed, and the brightness levels of the pixels on the left side of the targeted block 1802 are replaced in the same way as described above based on the information of the peripheral block 1801 adjacent thereto on the left. Then, a block 2402 illustrated in FIG. 22 is obtained. In a similar manner, the respective blocks of the inputted image are sequentially set as the targeted block, and the correction parameters are accordingly decided based on the information of the peripheral blocks.

As so far described, in the present preferred embodiment, the correction parameter is decided for each of the pixels in the targeted block by the correction controller 103 based on the information of the targeted block and the information of the peripheral block around the targeted block, and the image quality is corrected on a pixel-by-pixel basis by the image quality corrector 104 in accordance with the decided parameters. As a result, the difference in the brightness level between the blocks can be reduced, so that the face region is accurately detected.

### Preferred Embodiment 4

In the description of the preferred embodiments 2 and 3, the number of the divided blocks can be arbitrarily decided by the block divider 102. Below is described the case where the number of the blocks is fixed. In the case where the number of the blocks is fixed, the actual size of the face region and the block size may be different to each other, which makes it difficult to accurately detect the face region. Therefore, in a preferred embodiment 4 of the present invention, blocks are virtually combined in accordance with the size of the face region assumed by the face region detector 105, and the parameter is decided for each group of blocks virtually combined blocks by the correction controller 103.

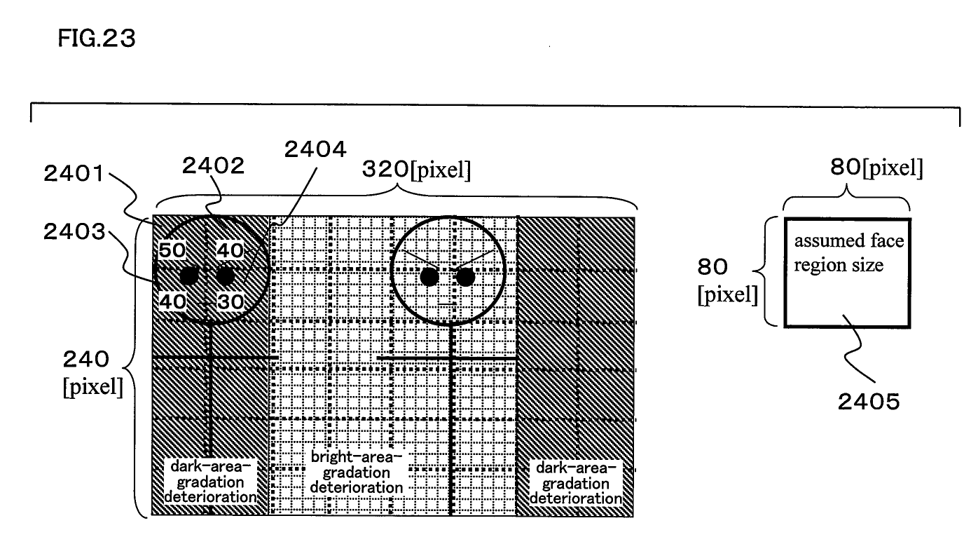

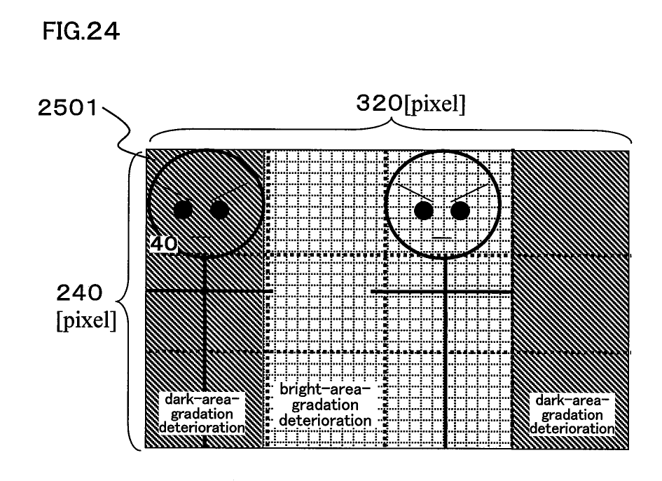

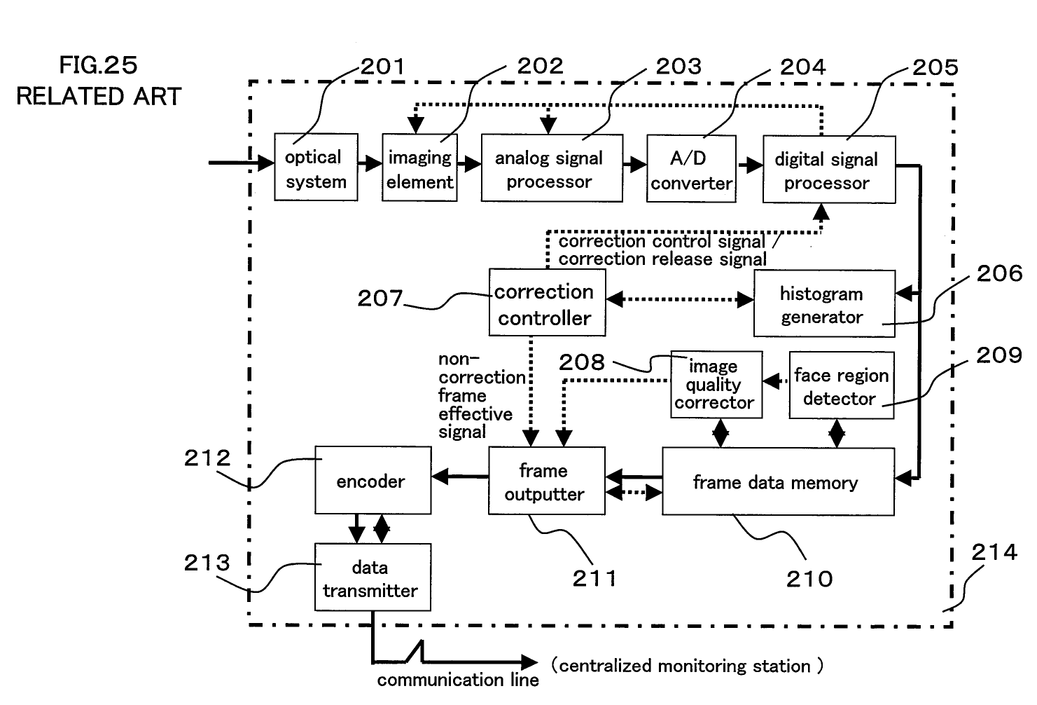

Below are described a method of virtually combining blocks and a method of deciding parameters for each group of the blocks virtually combined. As illustrated in FIG. 23, in the case where the size of the inputted image is QVGA (320×240), the number of the blocks is fixed to 8×6 (one block: 40×40), and the face region is a size 2405 of 80×80, the blocks are virtually combined so that the size of the combined blocks will be close to the size of the face region. FIG. 24 illustrates the blocks which are virtually combined. Blocks 2401, 2402, 2403 and 2404 illustrated in FIG. 23 are virtually combined, thereby constituting a combination block 2501, and the brightness level average of the block 2501 is an average value of brightness level averages of the respective blocks. More specifically, the brightness level average of the combination block 2501 is (50+40+40+30)/4=40. In the case where the gain correction is performed as the image quality correction, the parameters for the gain correction are decided by the correction controller 103 so that the brightness level average of the combination block 2501 will be 90. The parameter for the gain correction in the combination block 2501 is decided as x9/4. The parameter for the gain correction in the combination block 2501 thus decided serves as the parameter for the gain correction in the blocks virtually combined. The operation thereafter is similar to that of the preferred embodiments 2 and 3.

As thus far described, in the present preferred embodiment, blocks are virtually combined in accordance with the size of the face region assumed by the face region detector 105 in the case where the number of the blocks is fixed, and the parameter is decided by the correction controller 103 for each group of the blocks virtually combined. As a result, the face region can be accurately detected.

In the case where the number of blocks is fixed and the size of a block is larger than an assumed face region size, the respective blocks should be virtually divided so that the block can have a size close to the size of the face region.

The methods of deciding correction parameters ob a block-by-block or pixel-by-pixel basi, which were described in the preferred embodiments 1-4, are merely examples, and can be variously modified.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. An image processing method comprising:
a step of dividing an image based on image data into a plurality of blocks; and
a step of correcting an image quality of the image on a block-by-block basis based on information of the image data of the respective divided blocks.

2. An image processing device comprising:
an image data memory in which inputted image data is stored;
a data divider for dividing an image based on the image data into a plurality of blocks and generating the image data of the respective blocks;
an image quality corrector for correcting an image quality of the image; and
a correction controller for controlling the correction of the image quality by the image quality corrector on a block-by-block basis based on information of the image data of the respective blocks divided by the data divider.

3. The image processing device as claimed in claim 2, wherein the data divider can change the number of the blocks into which the image is divided.

4. The image processing device as claimed in claim 3, further comprising a particular region detector for detecting a particular region of the image, wherein
the data divider decides the number of the blocks into which the image is divided in accordance with a size of the particular region detected by the particular region detector.

5. The image processing device as claimed in claim 2, further comprising a particular region detector for detecting a particular region of the image, wherein
the data divider fixes the number of the blocks into which the image is divided, and
the correction controller combines a plurality of blocks adjacent to each other in accordance with a size of the particular region detected by the particular region detector, and controls the correction of the image quality by the image quality corrector for each group of the combined blocks based on the information of the image data of the combined blocks.

6. The image processing device as claimed in claim 2, wherein
the correction controller controls the correction of the image quality by the image quality corrector for each of targeted blocks for which the image quality is corrected by the image quality corrector, based on the information of the image data of only the targeted block.

7. The image processing device as claimed in claim 2, wherein
the correction controller controls the correction of the image quality by the image quality corrector for each of targeted blocks for which the image quality is corrected by the image quality corrector and for each pixel included in the targeted block, based on the information of the image data of the targeted block and a peripheral block around the targeted block.

8. The image processing device as claimed in claim 4, further comprising a selecting switch for changing whether or not the image quality is corrected and whether or not the particular region is detected.

9. The image processing device as claimed in claim 5, further comprising a selecting switch for changing whether or not the image quality is corrected and whether or not the particular region is detected.

10. The image processing device as claimed in claim 4, wherein the particular region is a face region of a person.

11. The image processing device as claimed in claim 5, wherein the particular region is a face region of a person.

12. The image processing device as claimed in claim 2, further comprising a block data memory in which the image data of the blocks divided by the data divider is stored, wherein it can be selected if the image data of the blocks is stored in the image data memory or the block data memory.

13. The image processing device as claimed in claim 2, wherein the image quality is corrected in a monitor mode and a moving-picture mode.

14. An imaging device comprising:
an imaging element for receiving an incident light of a photographic subject via an optical lens, converting the received light into an imaging signal and outputting the imaging signal;
an A/D converter for converting the imaging signal outputted from the imaging element into a digital signal;
a digital signal processor for digitally processing the digital signal outputted from the A/D converter;
the image processing device as claimed in claim 2 for processing the image data outputted from the digital signal processor; and
an image data outputter for outputting the image-processed image data outputted from the image processing device outside.
